(19) United States
(12) Patent Application Publication
(10) Pub. No.: US 2009/0100137 A1
(43) Pub. Date: Apr. 16, 2009

(54) METHOD AND APPARATUS FOR PROVIDING SERVICES IN A PEER-TO-PEER COMMUNICATIONS NETWORK

(75) Inventors: Narayanan VENKITARAMAN, Palatine, IL (US); Ross J. Lillie, Hoffman Estates, IL (US)

Correspondence Address: PRASS LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/870,766

(22) Filed: Oct. 11, 2007

(51) Int. Cl. G06F 15/16

(52) U.S. Cl. 709/205

(57) ABSTRACT

A method and apparatus that provides services in a peer-to-peer communications network is disclosed. The method may include determining at least one group to which a first application is associated, determining if there is at least one second application in the group, and if there is a second application, then sharing information with the second application.

### BACKGROUND OF THE DISCLOSURE

1. Field of the Disclosure

The disclosure relates to peer-to-peer communications in electronic devices.

2. Introduction

Traditional IP networking developed as an overlay on top of different types of link layers for communicating from a device to a remote device. The key applications, for instance, were the File Transfer Protocol (FTP) to move data from one device to another and the Network Virtual Terminal Protocol (TELNET) to log in to a remote device.

Utilizing this approach to communicate with a user is an afterthought and is often implemented as an overlay on top of device centric Internet. For instance there is an overlay of Simple Mail Transfer Protocol (SMTP) servers to deliver email and an overlay of Session Initiation Protocol (SIP) servers to enable an end point reach a user. Internet Protocol (IP) itself is peer-to-peer in nature and was based on the end-to-end argument of intelligent end points with no service related state in the core. However, the overlays on top of it, have been based on a client-server model with relatively dumb clients and with intelligence in the servers which reside the in core network. In such a model, the clients require the core network entities to understand session/application protocols to provide value to a user. Only the network has sufficient intelligence to act as a “proxy” for the user.

Some of the reasons for such an approach to gain hold have been (a) insufficient capabilities (processing power and battery power) of end points (such mobile phones) that users often use to communicate; (b) lack of continuous presence (home PC using dialup are not always connected, cell phone may be powered off or out of coverage, etc.); and (c) low bandwidth last hop connectivity. While most of these reasons are either not valid today or will not be valid in the near future, such approaches are still the main stream.

### SUMMARY OF THE DISCLOSURE

A method and apparatus that provides services in a peer-to-peer communications network is disclosed. The method may include determining at least one group to which a first application is associated, determining if there is at least one second application in the group, and if there is a second application, then sharing information with the second application.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 illustrates an exemplary diagram of a Universal Identity for Peering (uIP) network in accordance with a possible embodiment of the disclosure;

FIG. 2 is an exemplary diagram illustrating the possible applications and uIP middleware present in a communication device in accordance with a possible embodiment of the disclosure;

FIG. 3 illustrates an exemplary diagram of a communication device for implementing the peer-to-peer communication process in accordance with a possible embodiment of the disclosure;

FIG. 4 is an exemplary flowchart illustrating one possible process for providing services in a peer-to-peer communications system in accordance with one possible embodiment of the disclosure; and

FIG. 5 is an diagram illustrating the exemplary interactions of devices in a peer-to-peer communications network in accordance with a possible embodiment of the disclosure.

### DETAILED DESCRIPTION OF THE DISCLOSURE

Additional features and advantages of the disclosure will be set forth in the description which follows, and in part will be obvious from the description, or may be learned by practice of the disclosure. The features and advantages of the disclosure may be realized and obtained by means of the instruments and combinations particularly pointed out in the appended claims. These and other features of the present disclosure will become more fully apparent from the following description and appended claims, or may be learned by the practice of the disclosure as set forth herein.

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The present disclosure comprises a variety of embodiments, such as a method and apparatus and other embodiments that relate to the basic concepts of the disclosure.

This disclosure concerns applications developed using peer-to-peer (p2p) interactions between a subset of nodes in a network. Such applications may be developed using a p2p communications framework, such as the universal identity for peering (uIP) framework. The uIP framework is a software middleware architecture that facilitates the development of a variety of p2p applications. Some of the features provided by uIP are maintenance of one or more overlay identity spaces, maintenance of one or more overlay network layers to enable reachability to the associated overlay identity space, allowing data to be exchanged between applications within an overlay network and associated overlay namespace, as well as between applications in disparate overlay networks and associated overlay namespaces, and a set of application programming interfaces (APIs) enabling applications to utilize the features provided by the uIP middleware. Finally, in some other embodiments such applications may be developed without using an underlying p2p framework, but with the necessary p2p features built into the application.

While a peer-to-peer overlay network such as uIP provides establishes trust between groups of devices, it is up to the applications to implement the service logic. According to one aspect of the disclosure, applications may be enabled in the end point devices to find related applications in other end point devices. The applications may constitute a logical service group forming a service overlay employing overlay naming, addressing, and routing functions mapped to an underlying communications network.

The application within this group may be located on devices that span multiple underlying IP subnetworks, access networks and domains. The related applications may form a logical service group comprising a subset of all applications having access to the underlying communications network. Furthermore, no restrictions may be placed on which applications and their supporting devices that may comprise a logical service group.

In one embodiment, applications, for instance a Session Initiation Protocol (SIP) based VoIP application or user agent, on end point devices belonging to an individual user may discover each other to form a logical service group of applications associated with the user. In a further embodiment, applications may form groups on only a subset of the users devices that are associated with a specific function, such as devices used for work versus devices used for personal use. Applications that are part of a service group may also share state information (e.g., a location application may track a user's location and share it with the VoIP application in that group, the VoIP application shares call request information with other VoIP applications in the group). Similarly an idle mode application may determine that a device is going into idle mode and inform other devices in its group.

Finally, applications may cooperatively determine their behavior, such as which application(s) should receive requests, which should process and which should respond to a request. For example, a VoIP application residing in a home gateway and an application residing on an office personal computer (PC) may receive the request, the home gateway application may process the request based on user preferences and may ask an equivalent application residing on the user's mobile phone to answer the call. The application hosted on the office PC may process the request only if the equivalent application on the home PC is deemed to be unavailable. Applications may also cooperatively tailor service behavior based on state information that they share. For example, applications forming in a first service group corresponding to a devices of a set of friends, may share information such a user's playlist and browsing history. An application in the first service group may then provide this list to browsing applications in a second service group corresponding to devices of a user. This will be used by the browsing application to modify the list of advertised songs and media. The disclosure may enables devices in the service group may to provide services without requiring service specific support from other devices that are not part of the group.

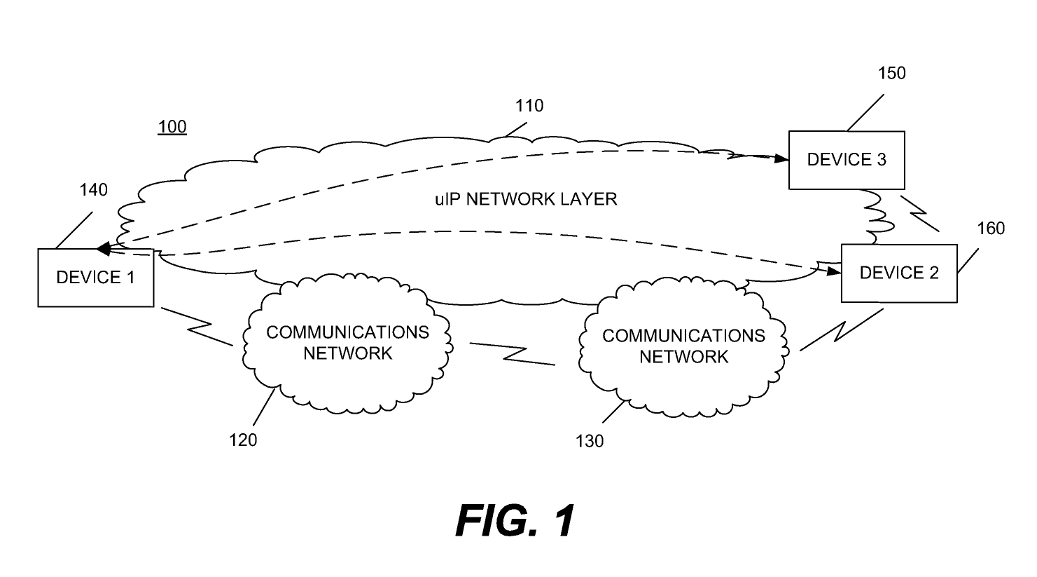

FIG. 1 illustrates an exemplary diagram of a peer-2-peer (p2p) network 100 in accordance with a possible embodiment of the disclosure In particular, the p2p network 100 may include a uIP network layer 110, multiple communications networks 120, 130, and multiple devices 140, 150, 160.

Devices 140, 150, 160 may be electronic devices belonging to one person, or shared by a family, friends, office, etc. For example, devices 140, 150, 160 may be mobile phones, wireless telephones, laptop computers, radios, personal computers, wired phones, MP3 players, portable computers, wireless radios, personal digital assistants PDA), residential gateways or any other communication device. Devices 140, 150, 160 may communicate directly through communications networks 120, 130 or using the uIP network layer 110. Communications networks 120, 130 may represent any possible communications network, including wireless communication networks, hardwired telephone networks, wireless local area networks (WLAN), the Internet, an intranet, etc. Note that their can be multiple co-existing uIP networks 100 with a device 140 belong simultaneously to multiple overlay networks.

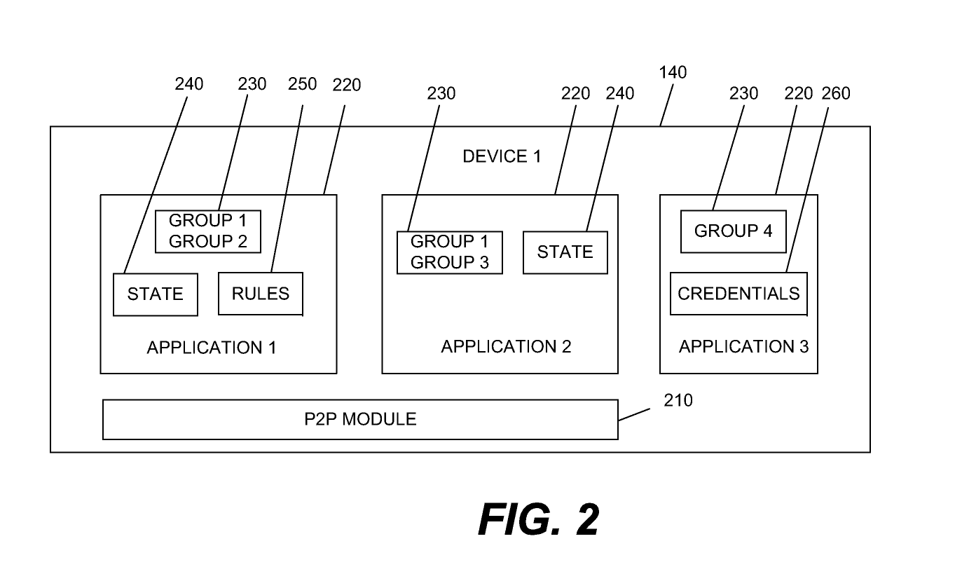

FIG. 2 is an exemplary diagram illustrating the possible applications 220 and p2p module 210 present in a communication device 140 in accordance with a possible embodiment of the disclosure. The p2p module 210 may be a single module or a collection of different modules providing the p2p functions necessary for applications 220 to implement the various embodiments of the disclosure. The applications 220 may be part of a one or more groups 230. For example, an application 220 in a mobile communication device of a particular user, such as a mobile phone, for example, may be present in two logical groups 230 of devices: all devices used for business functions, and all devices used for personal functions.

The first group 230 may include the user's office devices, such as an office PC, office phone, etc., and the latter group may correspond to the user's family devices, such as the user's home phone, home PC, spouses mobile phone, etc. Furthermore, some devices may be present in both groups 230.

The applications 220 within a given device may also maintain state information related to the logical functioning provided by the application 220 in concert with equivalent applications 220 located on other devices within a group 230. Such state information 240 may include local information such as the user's availability, bandwidth availability, as well as information about other devices and applications 220 within the logical group 230. Additionally, the application 220 may have rules 250 provided by user and other entities such as service provider and access provider that determine the behavior of the application 220. Finally, the application 220 may also have access to the necessary credentials 260, such as security keys that are necessary for the application 220 to join the groups 230, update directories and securely communicate with its group members.

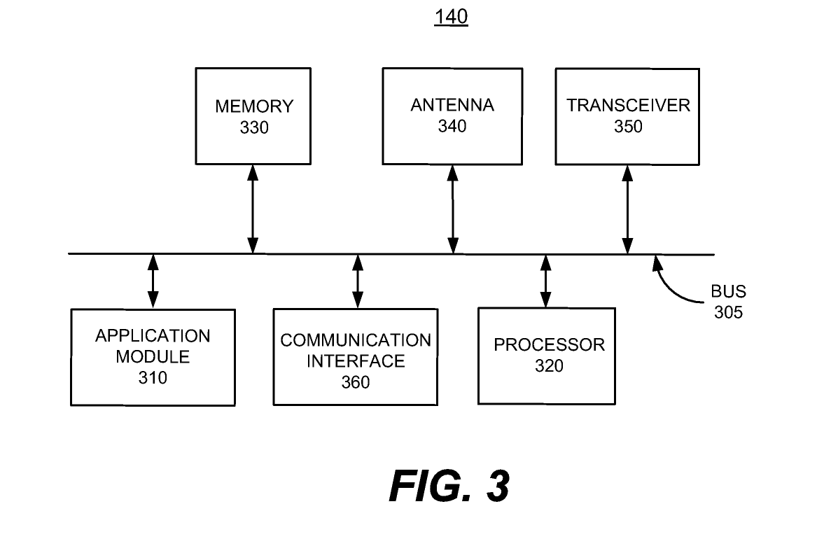

FIG. 3 illustrates an exemplary diagram of a communication device 140 for implementing the peer-to-peer communication process in accordance with a possible embodiment of the disclosure. The exemplary communication device 140 may include a bus 310, a processor 320, a memory 330, an antenna 340, a transceiver 350, a communication interface 360, and an application module 310. Bus 310 may permit communication among the components of the communication device 140.

Processor 320 may include at least one conventional processor or microprocessor that interprets and executes instructions. Memory 330 may be a random access memory (RAM) or another type of dynamic storage device that stores information and instructions for execution by processor 320. Memory 330 may also store temporary variables or other intermediate information used during execution of instructions by processor 320. Memory 330 may also include a read-only memory (ROM) which may include a conventional ROM device or another type of static storage device that stores static information and instructions for processor 320. Memory 330 may include a storage device that stores any type of media, such as, for example, magnetic or optical recording media and its corresponding drive.

Transceiver 350 may include one or more transmitters and receivers. The transceiver to 350 may include sufficient functionality to interface with any network or communications station and may be defined by hardware or software in any manner known to one of skill in the art. The transceiver 350 may be operable to support communication activities and links within the uIP network 100. The processor 320 is cooperatively operable with the transceiver 350 to support operations within the uIP network 100.

Communication interface 360 may include any mechanism that facilitates the communication via the communications network 100. For example, communication interface 360 may include a modem. Alternatively, communication interface 360 may include other mechanisms for assisting the transceiver 350 in communicating with other devices and/or systems via wireless connections. In some implementations of the uIP network 100, communication interface 360 may not be included in the exemplary communication device 140 when the communications handover process is implemented completely within the uIP network 100.

The communication device 140 may perform such functions in response to processor 320 by executing sequences of instructions contained in a computer-readable medium, such as, for example, memory 330, a magnetic disk, or an optical disk. Such instructions may be read into memory 330 from another computer-readable medium, such as a storage device or from a separate device via communication interface 360.

The uIP network 100 and the communication device 140 illustrated in FIGS. 1-3 and the related discussion are intended to provide a brief, general description of a suitable computing environment in which the disclosure may be implemented. Although not required, the disclosure will be described, at least in part, in the general context of computer-executable instructions, such as program modules, being executed by the communication device 140, such as a communications server, or general purpose computer. Generally, program modules include routine programs, objects, components, data structures, etc. that perform particular tasks or implement particular abstract data types. Moreover, those skilled in the art will appreciate that other embodiments of the disclosure may be practiced in communication network environments with many types of communication equipment and computer system configurations, including cellular devices, mobile communication devices, personal computers, hand-held devices, multi-processor systems, microprocessor-based or programmable consumer electronics, and the like.

For illustrative purposes, the operation of application module 310 and the peer-to-peer communication services process will be described below in relation to the block diagrams shown in FIGS. 1-3.

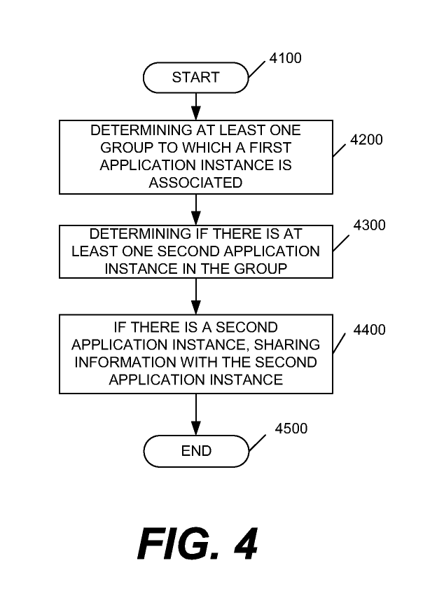

FIG. 4 is an exemplary flowchart illustrating one possible process for providing services in a peer-to-peer communications system in accordance with one possible embodiment of the disclosure The process begins at step 4100 and continues to step 4200 where the application module 310 determines at least one group 230 to which a first application 220 is associated. In one embodiment, this may be determined based on inputs from a user via a Graphical user interface (GUI) or a configuration file. For example, the user may indicate that an application 220 should join a group 230 called family.alice.p2p.net using an application GUI. Alternatively, the user may have created a configuration file or provided information in a database, such as a phonebook indicating a list of groups. Furthermore, the user may also provide information and credentials corresponding other devices such as website that hold information about user's friends and contact. This may be used by the application module 310 to determine the groups the first application 220 is associated.

In another embodiment, the application 220 may use rules to deduce the group 230 based on user action. For instance, if the user downloads and watches a file called Yellowstone.mpg, then an application 220 may join one or more group 230 based on that action. For example, an application 220 may use some rules along with user interest information to determine that it should join groups 230 named nature.interests.p2p.net and Yellowstone_mpg.p2pfileshare.com. User interest may be explicitly specified by the user or deduced based on user actions such as frequently played media.

In yet another embodiment, an application 220 can determine a group 230 to join based on state information, such as user location and context. For instance, if the user is in a particular GPS location, then an application 220 may map the location to a set of key words, such as Chicago, Soldier Field, etc. and then use that to determine a set of groups 230 to join. An application may also choose to join groups that a p2p module in its device to which it is already a part. A combination of these may also be used to determine the groups 230 to join. The application module 310 may also use information such as user input, location, context, timeout to determine when it should leave groups that it has joined.

At step 4300, the application module 310 may determine if there is at least one second application in the group 230. Note that the first and the second applications 220 may be in different devices in different subnets, for example. In one instance, the application module 310 may look for a complementary application. For example a VoIP application in a group may determine if there is a Universal Plug and Play (UPnP) application in the group to complement a VoIP call with picture sharing using UPnP. In another instance, the application module may look for a equivalent application, equivalent application being an application providing identical functionality or at least a subset of functionality of applications 220.

For instance, a SIP based VoIP application may look for other VoIP applications (based on SIP or other protocols, such as H.323) in other devices in the group. Applications 220 may utilize the namespace provided by the overlay network to identify themselves within the peer-to-peer group 230 and determine if there are related applications in one or more devices in its peer groups 230.

In one possible embodiment, this process may be done by using the p2p module 210 to find at least one directory service corresponding to the groups 230 and then utilizing the group's directory service to determine information about related applications 220 in the group 230. An application module 310 may also choose the directory service that it will use based on the group that it is joining. For instance, it may map the suffix portion of a group name to a directory service using a mapping table.

The mapping table may be configured statically be the user and may also be dynamically modified by enabling directory lookup applications register for specific suffixes. Thus, a DHT based lookup application may register for suffix, dht.net. Then, the application module 310 will use that lookup application to update a group name such as alice.dht.net. If one or more related applications 220 have already registered in the directory service of the group 230, the first application 220 then contacts any additional applications 220.

The directory lookup may use an application ID as a key or by providing a feature list and receiving a list of applications 220 that satisfy the requirements in the feature list. Some examples of directories that may be used for such a lookup are Domain Name Server (DNS), Distributed Hash Table (DHT), an Active Directory Server, a Home Subscription Server (HSS) in a IP Multimedia Subsystem (IMS). The directory service may also be provided as part of the p2p module 210. Group Information from the second application 220 may in turn be used to contact additional applications 220.

Optionally, the application module 310 may inform any additional applications 220 about its presence. In one embodiment, the application module 310 directly sends a message to the any additional applications 220 thereby notifying them of its presence. In another embodiment, this is done by registering with the p2p module 210, providing it the related applications criteria and receiving callbacks from the p2p modules 210 when subsequent related applications 220 are located in the group 230. In yet another embodiment, the second application informs the additional applications about the presence of the first application. This notification can be done automatically or after receiving an request message from the first application.

At step 4400, if the application module 310 determines that there is a second application 220 in the group 230, the application module 230 may share information with the second application 220. In one possible embodiment, this sharing operation may occur using the p2p module 210 using the uIP network layer 110. In another embodiment sharing occurs directly between the applications 220 directly via the communication networks 120 and 130. The information may include information about the identity and presence of a new application module 310 in the group 230 and state information 250 in application module 310, such as last updated time and revision number for user preference, for example. The state information 240 may also include information about the list of groups 230. This information may then trigger other application modules 310 to join additional groups 230 based on the list of groups 230. The process then goes to step 4500 and ends.

The application module 310 may also determine a subset of the equivalent applications 220 as a master set of applications 220. In addition, the application module 310 may change the configuration of the network to route requests to the master set of applications 220. For example, the SIP based application module 310 may generate a REGISTER message that maps a Address of Record to the contact address of another SIP based application module 310. In this manner, the application module 310 may route requests from network devices based on the changed network configuration.

Furthermore, the application module 310 may determine information about other devices and applications that are reachable from itself and may provide this information to at least one of the p2p module and at least another application 220 in its service group. For example, an application module 310 in a home network may detect the presence of another audio device or a VoIP application in a device in its local area network (using for example an advertisement or registration message).

Then, the application module 310 may make this device reachable from other members of its group 230. Thus, the application module 310 can extend the reach of local devices from a local subnet to members of its peer group. In one possible embodiment, the application module 310 may inform the p2p module about the IP address of the new device which in turn creates a new overlay routing path. In another possible embodiment, the application module 310 informs other application modules in its service group.

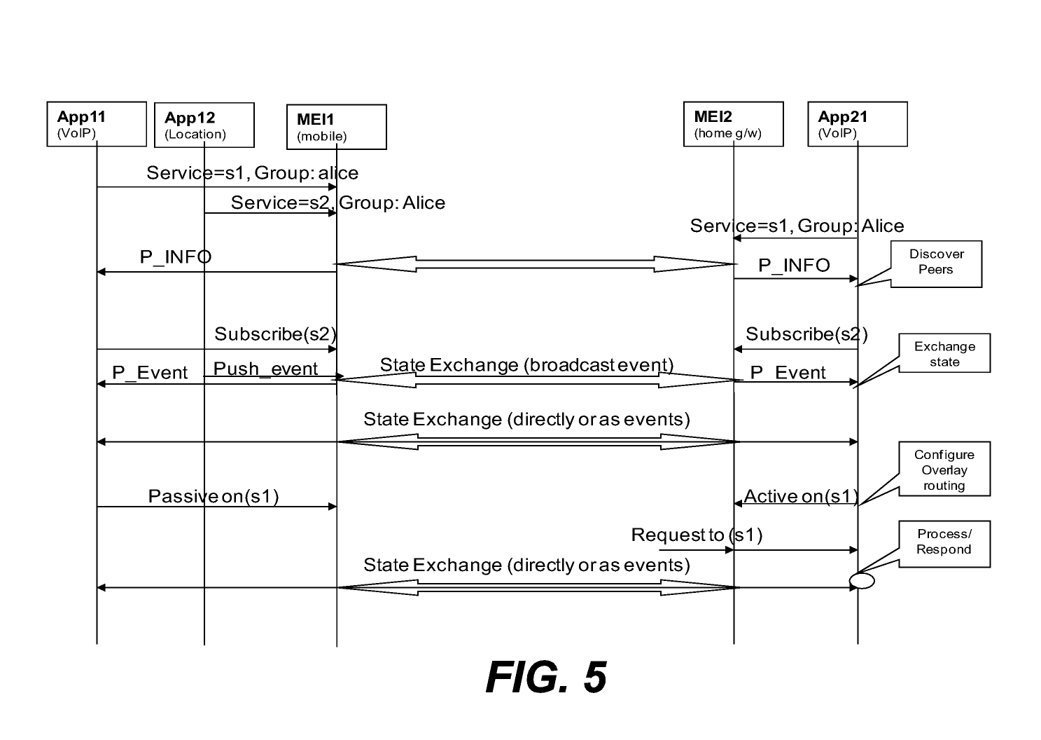

FIG. 5 is an diagram illustrating the exemplary interactions of devices in a peer-to-peer communications network in accordance with a possible embodiment of the disclosure. In this possible embodiment, a VoIP application 220 may be present in devices corresponding to a user (Alice), who has three devices, namely a mobile phone, a home gateway and an office PC, for example. Using uIP, these devices may find each other and form a group 230 (using the identity alice.motop2p.net, for example).

On start up, the VoIP applications 220 in each of these devices may register with the p2p module 210. While registering, the applications 220 may provide information, such as a key called the application-ID and/or their destination ports, that may be used by the p2p module 210 to correlate different applications 220 and determine if applications 220 are related. The application 220 may also indicate to the p2p module 210 the list of application_ids to which it is related. The application 220 may receive a callback from the p2p module 210 when other related applications 220 are found in other devices in the group 230. In other embodiments, an application 220 may indicate its capabilities and interest in more detail in Type Length Value (TLV) format or Extended Markup Language (ML) format. These formats may then be used for find related applications. The applications 220 may now exchange messages (directly using sockets or via event API provided by uIP, etc.) to coordinate their behavior. The applications 220 may share information, such as user provided state or other local state information 250.

The application 220 (VoIP, in this example) may also subscribe to events from other applications 220, such as a location application. For instance, when the user location is updated, the location application 220 will send a broadcast to the group 230 using uIP APIs. The VoIP applications 220 in the group 230 can use this information to provide services, such as follow me, for example.

Additionally, a subset of the applications 220 can be active and others can become passive. For example the application 220 in Alice's mobile phone may become passive when its device enters idle or sleep mode. The passive node may request the network not to forward packets to them. For instance, the VoIP application 220 in Alice's mobile phone may determine that as there are VoIP applications 220 in more capable devices, and as such, it may request that the network 110 forward packets to those nodes.

In one embodiment, the passive device, a mobile phone for example, may obtain the contact address of a second VoIP application 220 in an active device its group 230 and generate a SIP message with maps its Address of Record (AoR) to the contact address of the second VoIP application 220, thereby requesting the network to redirect packets destined to itself to one of the active devices in the group 230. An application 220 may also inform its peer applications 220 in the group 230 that its device is becoming passive on behalf of other applications 220 in that device. This in turn, may result in one of the devices in the group 230 becoming an active device and requesting the network to forward packets destined to the passive device to a different device. This can also result in reduction or elimination of group management traffic (such as keep-alive messages) destined to the device that is entering into an idle mode. The device that becomes passive may also provide the active device with the necessary security credentials (for instance a key or a message authentication code) to act on its behalf.

When a call arrives, one or more of the active nodes may then determine which node should process the call request based on user preferences, user state, etc., for example. For instance, if the all the phones should ring, then one of the master nodes may forward the request to the passive nodes, for example a mobile node. In another embodiment, the master node may provide only part of the information, such as the CallerID, CallID from the request message. The recipient then may recreate the call request from the information provided by the master node. In another example, a first VoIP application 220 in a group 230 can share state information 240 such as the session ids of the current calls in progress, the identity of the other party in the call, and the associated security credentials with other VoIP applications 220 in its group 230. This information can be used a second VoIP application 220 in a group 230 to join the call (for instance by generating a SIP INVITE with join header) or move the call to itself. (for instance by generating a SIP INVITE with a replaces header).

Note that while the above embodiment is in the context of a VoIP application 220, the basic steps remain the same for other classes of applications 220, as well. For example, to create a phone book application which keeps entries in multiple devices in sync, the phone book application 220 simply joins the group 230 (say phbook.alice.motop2p.net, for example). In this manner, they may now share state information phone book entries) as uIP events.

Similarly, a set of applications 220 in a group 230 can share state information 240 such as user's browsing history and media playlist with other peer applications. Such state information 240 received from the peers may then by used by the application 220 to provide suggestions to a user about other information (such as media content) to which the user may be interested.

Additionally, a VoIP application 220, for example, can find another UPnP based application such as a control point in its group and share information, such as the identity of second device or a second group in which the VoIP application 220 is in communication. The UPnP application 220 can then initiate communication with its peer UPnP application 220, such as a media server or a media renderer in the second device or second group. Thus, using possible embodiments of the invention, applications 220 that reside in multiple devices can coordinate to provide services without requiring service specific support from core network elements.

Embodiments within the scope of the present disclosure may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the disclosure are part of the scope of this disclosure. For example, the principles of the disclosure may be applied to each individual user where each user may individually deploy such a system. This enables each user to utilize the benefits of the disclosure even if any one of the large number of possible applications do not need the functionality described herein. In other words, there may be multiple instances of the application module 310 in FIGS. 3 and 4 each processing the content in various possible ways. It does not necessarily need to be one system used by all end users. Accordingly, the appended claims and their legal equivalents should only define the disclosure, rather than any specific examples given.

We claim:

1. A method of providing services in a peer-to-peer communications network, comprising:
determining at least one group to which a first application is associated;
determining if there is at least one second application in the group; and
if there is a second application, then sharing information with the second application.

2. The method of claim 1, further comprising:
determining a registry service corresponding to the at least one group and registering information corresponding to the first application in the registry service.

3. The method of claim 1, wherein the step of determining at least one group is based on at least one of user action, user context, device location, state information in the device hosting the application, and state information obtained from a second device with information corresponding to the user.

4. The method of claim 1, wherein the step of determining if there is at least one second application in the group is performed by registering with a p2p module and receiving a call back from the p2p module

5. The method of claim 1, wherein the step of determining if there is at least one second application in the group is performed by determining an IP address of a device using an identifier corresponding to the group and sending a message to that IP address, the device being one of a directory server, a device in the group, and a device with an equivalent application.

6. The method of claim 1, wherein the first and the second applications are in different devices in different subnets.

7. The method of claim 1, further comprising:
receiving information about a third application from the second application.

8. The method of claim 1, further comprising:
receiving a first message;
creating a second message using information in the first message; and
sending the second message to at least one of the peer-to-peer module and another application in the group

9. The method of claim 1, wherein the second application is equivalent to the first application.

10. The method of claim 1, further comprising:
changing a routing behavior of packets destined to at least one of an identifier corresponding to the group, the device hosting the first application and the device hosting the second application.

11. A mobile communication device that provides services in a peer-to-peer communications network, comprising:
a memory; and
an application module that determines at least one group to which a first application is associated, determines if there is at least one second application in the group, and if there is a second application in the group, then the application module shares information with the second application.

12. The mobile communication device of claim 11, wherein the application module determines a registry service corresponding to the at least one group and registering information corresponding to the first application in the registry service.

13. The mobile communication device of claim 11, wherein application module determines if there is at least one second application in the group is performed by registering with a p2p module and receiving a call back from the p2p module

14. The mobile communication device of claim 11, wherein the application module determines if there is at least one second application in the group is performed by determining an IP address of a device using an identifier corresponding to the group and sending a message to that IP address, the device being one of a directory server, a device in the group, and a device with an equivalent application.

15. The mobile communication device of claim 11, wherein the first and the second applications are in different devices in different subnets.

16. The mobile communication device of claim 1, wherein the application module receives information about the second application.

17. The mobile communication device of claim 11, wherein the application module receives information about a third application from the second application.

18. The mobile communication device of claim 11, wherein the application module receives a first message, creates a second message using information in the first message, and sends the second message to at least one of the peer-to-peer module and another application in the group.

19. The mobile communication device of claim 11, wherein the second application is equivalent to the first application.

20. The mobile communication device of claim 11, wherein the application module changes a routing behavior of packets destined to the group based upon the shared information.
